(19) United States
(12) Patent Application Publication
(10) Pub. No.: US 2007/0000731 A1
(43) Pub. Date: Jan. 4, 2007

(54) Lubricating device

(76) Inventors: Gerhard Meixner, Filderstadt (DE); Andreas Strasser, Rudersberg (DE)

Correspondence Address: STRIKER, STRIKER & STENBY, 103 EAST NECK ROAD, HUNTINGTON, NY, 11743, US

(21) Appl. No.: 11/455,318

(22) Filed: Jun. 19, 2006

(30) Foreign Application Priority Data
Jun. 30, 2005 (DE) 10 2005 030537.7

(51) Int. Cl. F16N 21/00

(52) U.S. Cl. 184/105.3

(57) ABSTRACT

A lubricating device for lubricating a tool unit includes a lubricating unit, wherein the lubricating unit is configured for using a damming motion for lubricating the tool unit.

### CROSS-REFERENCE TO A RELATED APPLICATION

The invention described and claimed hereinbelow is also described in German Patent Application DE 102005030537.7 filed on Jun. 30, 2005. This German Patent Application, whose subject matter is incorporated here by reference, provides the basis for a claim of priority of invention under 35 U.S.C. 119(a)-(d).

### BACKGROUND OF THE INVENTION

The invention is based on a lubricating device, in particular a handheld power tool lubricating device, for lubricating a tool unit.

A lubricating device for lubricating a tool receptacle of a handheld power tool has already been proposed, having a lubricant tube and a means for distributing the lubricant in the tool receptacle.

### SUMMARY OF THE INVENTION

The invention is based on a lubricating device, in particular a handheld power tool lubricating device, for lubricating a tool unit, having a lubricating unit.

It is proposed that the lubricating unit is intended for using a damming motion for lubricating the tool unit. An automatic lubrication of the tool unit, which is advantageous for the service life of the tool unit, can be attained by a suitable embodiment of the invention.

“Automatic” lubrication should be understood in particular to mean lubrication that can be done without intentional action on the part of a user. Moreover, a “damming motion” should be understood to mean in particular a motion by which the tool unit can be put into or out of a dammed state or into or out of a storage state, such as inserting or removing the tool unit or introducing or removing a power tool, to which the tool unit is secured, into or out of a storage unit, closing and/or opening a storage unit in which the tool unit is disposed, and so forth.

The tool unit may be formed by a tool receptacle, such as a drill chuck, clamping tongs, a clamping flange, and so forth, and/or by an insert tool, such as a drill and so forth. The term “intended” should be understood in particular to mean “equipped” and/or “designed”.

Advantageously, the lubricating device has a coupling region which is intended for coupling with the tool unit. The coupling region can advantageously be adapted to the tool unit, and in particular, effective contact lubrication of a region of the tool unit contacting the coupling region can be achieved. A readily perceptible additional use is also created.

If the coupling region is embodied as a receiving region for receiving the tool unit, then advantageous protection of the tool unit can additionally be attained, and unwanted spreading of a lubricant upon lubrication can be avoided.

It is also proposed that the lubricating unit is intended for lubricating the tool unit upon a motion of the tool unit relative to the coupling region. As a result, energy from the coupling motion can advantageously be utilized to drive the lubricating unit, and an additional drive device for the lubricating unit can be avoided. Upon coupling of the tool unit to the coupling region, a pressure force exerted by the tool unit on the lubricating unit can advantageously be utilized for driving a lubricant spray system.

Another advantageous utilization of a motion of the tool unit relative to the coupling region, specifically with a view to uniform lubrication of large regions of the tool unit, can be attained in that the coupling region includes a guide face, which is intended for guiding the tool unit and which has at least one lubrication portion. As a result, a compact design of the lubricating device is furthermore achieved, since a surface intended for guidance is advantageously utilized for lubrication purposes.

A further increase in the compactness of the lubricating device can be attained by providing that it has a lubricant conduit unit, which is intended for carrying a lubricant and has an outer face which is embodied as a coupling region. To enable lubricating an interior region of the tool unit, the lubricant conduit unit, upon coupling of the tool unit to the coupling region, can engage an interior region of the tool unit. In an embodiment of the tool unit as a tool receptacle, this is especially suitable; the lubricant conduit unit can engage an interior region of the tool receptacle that is intended to receive a tool.

In a further feature of the invention, it is proposed that the lubricating device has a securing device for securing the lubricating unit to a storage unit that is intended for storing a handheld power tool. As a result, lubrication of a tool unit secured to a handheld power tool can be achieved, and the handheld power tool can be placed in a region intended for it to be set aside in. The storage unit can advantageously be embodied as a carrying unit for the handheld power tool. The securing device makes for excellent stability of the lubricating device, for instance when the hand held power tool is being put away or removed and/or when the storage unit is being carried around.

Accessibility to the coupling region, especially upon coupling of the tool unit, secured to the handheld power tool, to the coupling region, can be enhanced in a simple way if the lubricating device has a bending element, which is intended to enable a motion of the coupling region relative to the storage unit when a lubricating unit is secured to the storage unit. The bending element can be embodied as a spring element, such as an elastic plastic part, as a metal spiral spring, and so forth, and/or as a flexible element, such as a film hinge.

To prevent damage to a coupling region that is movable in the storage unit, the lubricating device has a limiting device, which is intended to limit a relative motion between the coupling region and the storage unit when a lubricating unit is secured to the storage unit.

It is also proposed that the lubricating unit has a sponge means. As a result, especially uniform lubrication of a region of the tool unit can be attained, since the sponge means, which is for instance of felt, can because of its high absorption be saturated with lubricant, and no additional saturation operation has to be performed.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a carrying case with a lubricating device in accordance with the present invention and a hammer drill placed in it;

FIG. 2 shows the carrying case of FIG. 1, with the lubricating device in accordance with the present invention and a tool holder received in the lubricating device, in a sectional view; and

FIG. 3 shows the carrying case of FIG. 1 with an alternative lubricating device in accordance with the present invention.

### DESCRIPTION OF THE PREFERRED EMBODIMENTS

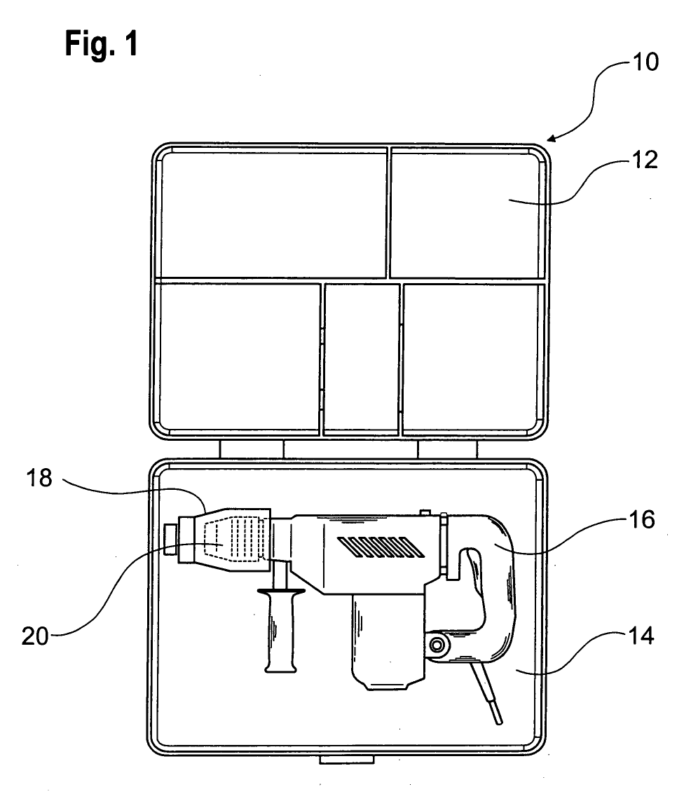

FIG. 1 shows a storage unit 10, embodied as a handheld power tool carrying unit, with a lid 12 of the carrying case and a base 14 of the carrying case, in which base a handheld power tool 16, embodied as a hammer drill, is placed. A lubricating device, embodied as a tool holder receptacle 18, is secured to the base 14 of the carrying case, and a tool unit 20 of the hammer drill 16, the tool unit being embodied as a tool holder, is received in this lubricating device.

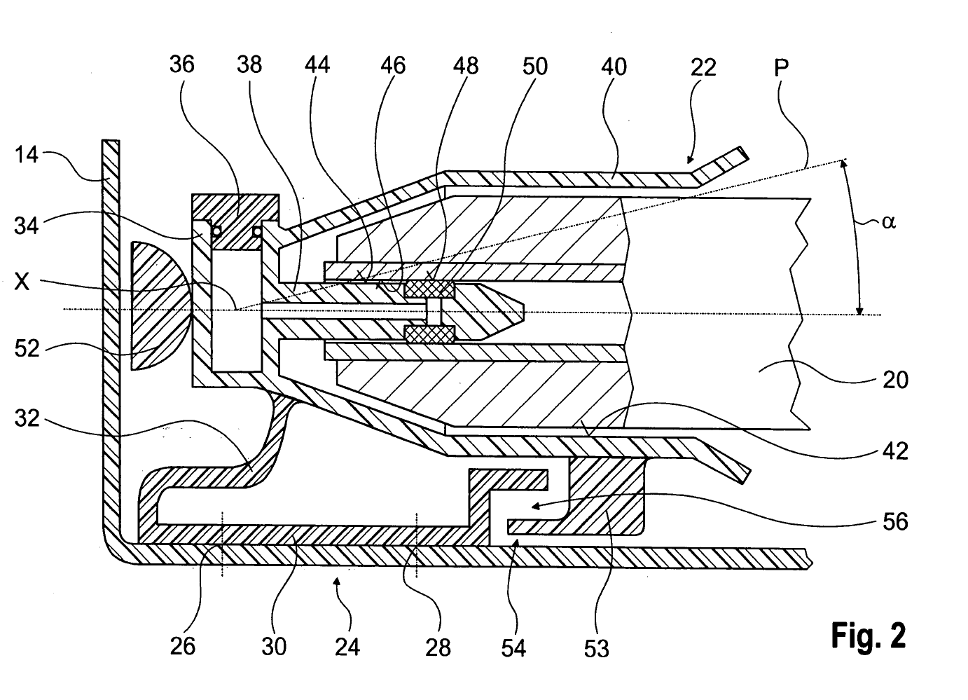

The lubricating device, which is shown in further detail in a sectional view in FIG. 2, has a lubricating unit 22. This unit includes a securing device 24, with a bottom plate 30 secured to the base 14 of the carrying case by securing means 26, 28; a plastic bending element 32; a lubricant tank 34 with a lid 36; a lubricant conduit unit 38, embodied as a lubricating bolt, for carrying a lubricant; and a cap 40. An inner face of this cap 40 forms a coupling region 42, which is embodied as a receiving region for receiving the tool unit 20.

A further coupling region 44 is formed by an outer face of the lubricant conduit unit 38 and is coupled to an interior region 46 of the tool unit 20. The coupling region 44 is also embodied as a guide face, which serves to guide the tool unit 20 and has a lubrication portion 48; the lubrication portion 48 is formed by a circumferential surface of an annular sponge means 50 embodied as a felt element. Because of this embodiment of the coupling region, a damming motion, which in this exemplary embodiment is placement of the hammer drill 6 into or its removal from the storage unit 10, is utilized for lubricating the interior region 46.

The bending element 32, which is embodied as a plastic spring element, is in a tensed state and exerts a spring restoring force on the cap 40 when a tool unit 20 is being received in the cap 40. The cap 40, the lubricant tank 34, and the lubricant conduit 38, which are rotatably supported about a pivot point X, rotate by an angle a as a result of the spring restoring force into a receiving position P, when the tool unit 20 is being removed, which offers easy access to the coupling region 42, embodied as a receiving region, the next time the handheld power tool 16 is placed in the storage unit 10.

The lubricating unit 22 is moreover braced in the storage unit 10 by ribs 52, 53, which offer great stability to the lubricating unit 22, especially if the storage unit 10 is loaded by strong pulses, such as if it falls down. To prevent damage to the lubricating unit 22, the lubricating device is provided with a limiting device 54. To that end, the rib 53 and the bottom plate 30 are designed such that a motion of the cap 40 relative to the base 14 of the carrying case is limited by an interlock 56.

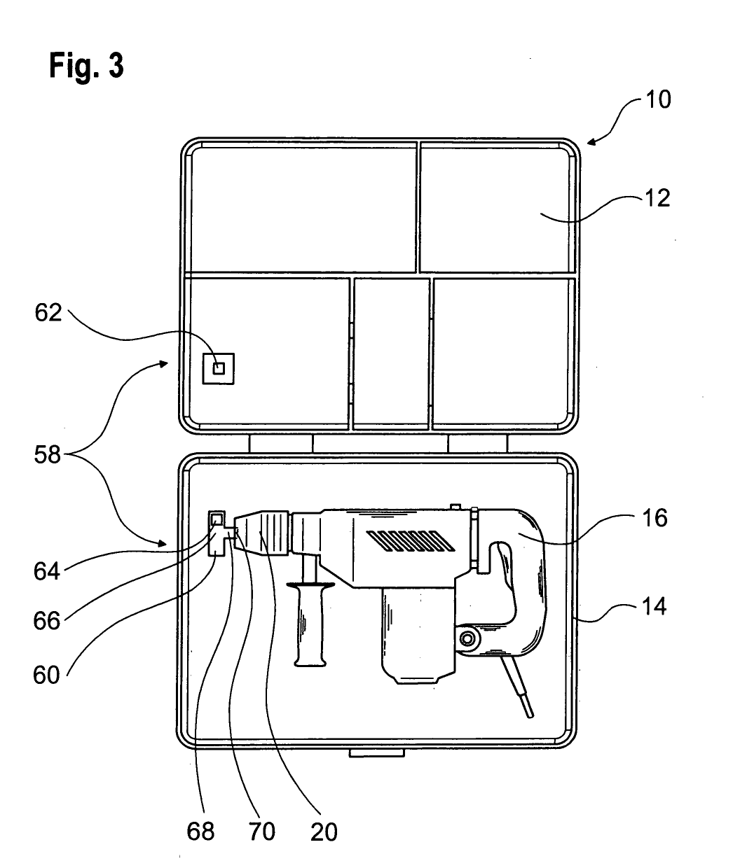

FIG. 3 shows the storage unit 10 with the handheld power tool 16 placed in it; this storage unit 10 is provided with an alternative lubricating device. This lubricating device has a lubricating unit 58, which includes a spray system 60, secured in the base 14 of the carrying case, and a bolt 62, secured to the lid 12 of the carrying case. The spray system 60 has a pushbutton 64, a lubricant tank 66, and a spray conduit 68 with a coupling region 70, which engages the interior region 46 of the tool unit 20 (FIG. 2).

Because of this embodiment, a damming motion, which in this exemplary embodiment is the closure of the storage unit 10, is utilized for lubricating the tool unit, specifically because pressing of the bolt 62 onto the pushbutton 64 causes a lubricant to be sprayed into the tool unit 20.

It will be understood that each of the elements described above, or two or more together, may also find a useful application in other types of constructions differing from the types described above.

While the invention has been illustrated and described as embodied in a lubricating device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A lubricating device for lubricating a tool unit, comprising a lubricating unit, said lubricating unit being configured for using a damming motion for lubricating the tool unit.

2. A lubricating device as defined in claim 1; and further comprising a coupling region configured for coupling with the tool unit.

3. A lubricating device as defined in claim 2, wherein said coupling region is configured as a receiving region for receiving the tool unit.

4. A lubricating device as defined in claim 2, wherein said lubricating unit is configured for lubricating the tool unit upon a motion of the tool unit relative to said coupling unit.

5. A lubricating device as defined in claim 2, wherein said coupling region includes a guide face, which is configured for guiding the tool unit which has at least one lubrication portion.

6. A lubricating device as defined in claim 2; and further comprising a lubricant conduit unit configured for carrying a lubricant and having an outer face configures as said coupling region.

7. A lubricating device as defined in claim 1; and further comprising a storage unit for storing a handheld power tool; and a securing device for securing said lubricating unit to said storage unit.

8. A lubricating device as defined in claim 2; and further comprising a bending element configured for enabling a motion of said coupling region relative to a storage unit when said lubricating unit is secured to said storage unit.

9. A lubricating device as defined in claim 8; and further comprising a limiting device for limiting a relative motion between said coupling region and said storage unit when said lubricating unit is secured to said storage unit.

10. A lubricating device as defined in claim 1, wherein said lubricating unit has a sponge means.

11. A handheld power tool carrying unit, comprising a lubricating device including a lubricating unit, said lubricating unit being configured for using a damming motion for lubricating the tool unit.
